(19) United States
(12) Patent Application Publication
(10) Pub. No.: US 2017/0216872 A1
(43) Pub. Date: Aug. 3, 2017

(54) STICKER HALF-CUTTING APPARATUS

(71) Applicant: Se-Jin LEE, Namyangju-si, Gyeonggi-do (KR)

(72) Inventor: Se-Jin LEE, Namyangju-si (KR)

(21) Appl. No.: 15/500,930

(22) PCT Filed: Jul. 17, 2015
(86) PCT No.: PCT/KR2015/007467

§ 371 Date: Jan. 31, 2017

(30) Foreign Application Priority Data
Aug. 1, 2014 (KR) 10-2014-0098890

(51) Int. Cl. B05C 1/08; B65H 35/02; B05B 12/08; B26D 7/08; B26F 1/38

(52) U.S. Cl. CPC B05C 1/0813; B26D 7/088; B26F 1/384; B05C 1/0873; B05B 12/084; B65H 35/02; B05B 9/01

(57) ABSTRACT

The present invention comprises: a support roller part rotating while supporting the lower side of a transferred sticker sheet; a half-cutting roller part provided at the top of the support roller part so as to rotate by engaging with the support roller part, and having a half cutter for cutting a printed part of the sticker sheet passing the support roller part; and an anti-adhesion fluid supplying unit for applying an anti-adhesion fluid on the surface of the half cutter coming into contact with the printed part of the sticker sheet.

### TECHNICAL FIELD

The present invention relates to a sticker half-cutting apparatus, and more particularly, to a sticker half-cutting apparatus which produces a sticker complete product by cutting a sticker sheet.

### BACKGROUND ART

A normally produced sticker may include a sticker sheet which has a printed part formed on the top surface thereof, and has an adhesive applied to the back surface thereof, and release paper which protects the adhesive on the lower end of the sticker sheet and is removed from the sticker when it is used.

That is, when a sticker sheet is made to pass between a magnetic cylinder having a processed half cutter connected therewith, and a roller, a printed part of the sticker sheet is cut in the shape of the half cutter by pressure applied to the sticker sheet, and accordingly, a sticker product is produced.

As a relevant prior art related to the present invention, Korean Patent Registration No. 10-1314948 (registered on Sep. 27, 2013) discloses an apparatus for manufacturing a sticker for nails using pressure and a sticker for nails manufactured using the same.

### DETAILED DESCRIPTION OF THE PRESENT DISCLOSURE

### Technical Objects

An object of the present invention is to provide a sticker half-cutting apparatus which can cut a sticker sheet efficiently and enhance a production speed on a sticker complete product.

### Technical Solving Means

According to the present invention, a sticker half-cutting apparatus includes: a support roller part which rotates while supporting the lower portion of a transferred sticker sheet; a half-cutting roller part which is installed on the upper portion of the support roller part to rotate by engaging with the support roller part, and includes a half cutter for cutting a printed part of the sticker sheet passing through the support roller part; and an anti-adhesion fluid supplying unit which applies an anti-adhesion fluid on the surface of the half cutter coming into contact with the printed part of the sticker sheet.

In addition, the anti-adhesion fluid supplying unit may include: an anti-adhesion fluid application roller part which adsorbs the anti-adhesion fluid and rotates by engaging with the half-cutting roller part, and applies the anti-adhesion fluid on the surface of the half cutter; and an anti-adhesion fluid supply part which supplies the anti-adhesion fluid to the anti-adhesion fluid application roller part.

In addition, the anti-adhesion fluid application roller part may include: a roller member which rotates by engaging with the half-cutting roller part; and an anti-adhesion fluid application member which is connected with the outer circumference of the roller member to adsorb the anti-adhesion fluid supplied from the anti-adhesion fluid supply part, and which comes contact with the half cutter to apply the adsorbed anti-adhesion fluid on the surface of the half cutter.

In addition, the anti-adhesion fluid application member may be formed of a porous moisture absorption material.

In addition, the half-cutting roller part may include: a cylinder member which rotates by engaging with the support roller part; and a half-cutting member which is connected with the outer circumference of the cylinder member and has a plurality of half cutters protruding therefrom.

In addition, the half-cutting member is attachably and detachably installed on the outer circumference of the cylinder member.

In addition, the anti-adhesion fluid may be formed of a material comprising silicon or oil.

In addition, the anti-adhesion fluid supply part may include: an anti-adhesion fluid supply tank which stores the anti-adhesion fluid; a spray nozzle which is installed on the anti-adhesion fluid supply tank to supply the anti-adhesion fluid to the anti-adhesion fluid application roller part; and a controller which controls the operation of the spray nozzle.

In addition, the controller may control spraying of the spray nozzle to spray the anti-adhesion fluid at a predetermined time interval.

In addition, the anti-adhesion fluid supply part may further include a measurement sensor which measures a degree of adsorption of the anti-adhesion fluid supplied to the anti-adhesion fluid application roller part.

### Advantageous Effect

According to the present invention, a separate roller holding a slippery liquid therein is installed on the upper portion of a magnetic cylinder connected with a processed half cutter, and applies the slippery liquid to the half cutter when the magnetic cylinder rotates, such that the adhesive of the sticker can be prevented from sticking to the half cutter.

In addition, the present invention can prevent a part of the sticker sheet cut through the half cutter from sticking to the half cutter, such that a defect rate can be reduced when a sticker complete product is produced, and accordingly, there is an effect of increasing a production speed according to the production of the sticker complete product.

### BRIEF DESCRIPTION OF DRAWINGS

FIG. 1 is a schematic view showing a conveyance path of a sticker half-cutting apparatus according to an exemplary embodiment of the present invention;

FIG. 2 is a view showing a structure of a sticker sheet of the sticker half-cutting apparatus according to an exemplary embodiment of the present invention;

FIG. 3 is an exploded perspective view showing a structure of a sticker half-cutting apparatus according to an exemplary embodiment of the present invention;

FIG. 4 is a perspective view showing a half-cutting roller part of the sticker half-cutting apparatus according to an exemplary embodiment of the present invention;

FIG. 5 is a perspective view showing the operation of the sticker half-cutting apparatus according to an exemplary embodiment of the present invention;

FIG. 6 is a cross section view showing the sticker half-cutting apparatus which cuts the sticker sheet according to an exemplary embodiment of the present invention;

FIG. 7 is a perspective view showing a sticker half-cutting apparatus according to another exemplary embodiment of the present invention; and

FIG. 8 is a perspective view showing the operation of the sticker half-cutting apparatus according to another exemplary embodiment of the present invention.

### BEST MODE FOR EMBODYING THE INVENTION

Hereinafter, preferred embodiments of the present invention will be described in detail with reference to the accompanying drawings.

The advantages and features of the present invention and methods for achieving these will be clear by referring to the embodiments described in detail below with reference to the accompanying drawings.

The exemplary embodiments may, however, be embodied in many different forms and should not be construed as limited to the exemplary embodiments set forth herein. Rather, the exemplary embodiments are provided so that this disclosure will be thorough and complete, and will fully convey the scope of the application to those of ordinary skill in the art. The present invention is only defined by the claims.

In addition, in the description of the exemplary embodiments, certain detailed explanations of related art are omitted when it is deemed that they may unnecessarily obscure the essence of the present invention.

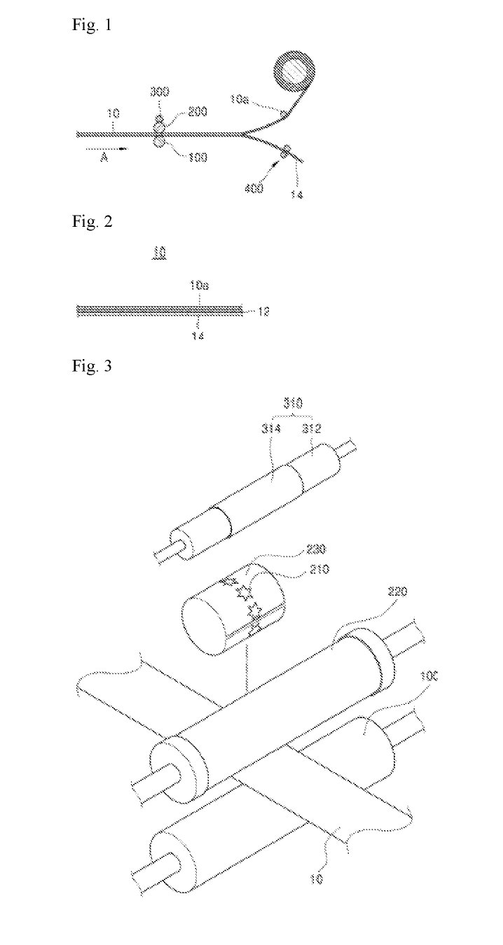

FIG. 1 is a schematic view showing a conveyance path of a sticker half-cutting apparatus according to an exemplary embodiment of the present invention, and FIG. 2 is a view showing a structure of a sticker sheet of the sticker half-cutting apparatus according to an exemplary embodiment of the present invention.

As shown in FIG. 1, the sticker half-cutting apparatus according to an exemplary embodiment includes a support roller part 100, a half-cutting roller part 200, and an anti-adhesion fluid supplying unit 300.

A sticker sheet 10 which passes between the support roller part 100 and the half-cutting roller part 200 along a conveyance path (A) is formed in a multilayered shape, including a printed part 10a having an adhesive 12 applied to the bottom surface thereof, and release paper 14 which is removably connected with the printed part 10a, as shown in FIG. 2.

The sticker half-cutting apparatus makes the sticker sheet 10 transferred along the conveyance path (A) pass between the support roller part 100 and the half-cutting roller part 200, such that the printed part 10a of the sticker sheet 10 is cut in a predetermined shape.

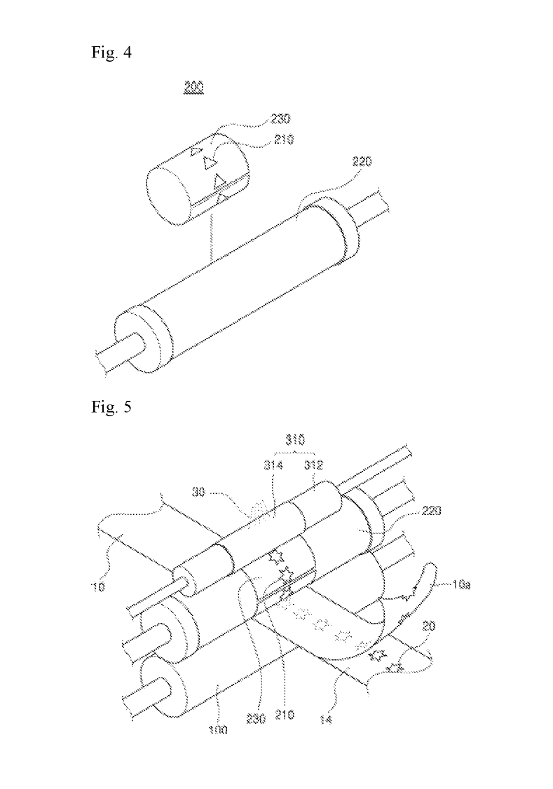

In other words, when the sticker sheet 10 passes between the support roller part 100 and the half-cutting roller part 200 which rotate in different directions while pressing the upper portion and the lower portion of the sticker sheet 10, a shape part 20 (see FIG. 4) having a predetermined pattern is cut from the printed part 10a.

The sticker half-cutting apparatus provided to perform the above-described operation includes the support roller part 100, the half-cutting roller part 200, and the anti-adhesion fluid supplying unit 300.

The support roller part 100 rotates while supporting the lower portion of the transferred sticker sheet 10.

The half-cutting roller part 200 is installed adjacent to the support roller part 100, and rotates while pressing the upper portion and the lower portion of the sticker sheet 10 with the support roller part 100, such that the shape part 20 is cut from the printed part 10a of the sicker sheet 10.

In the present embodiment, the half-cutting roller part 200 is disposed on the upper portion of the support roller 100. However, this should not be considered as limiting. According to the present invention, there may be various variations such as the half-cutting roller part 200 being installed on the side portion of the support roller part 100.

The half-cutting roller part 200 includes a half cutter 210 for cutting the printed part 10a of the sticker sheet 10 passing through the support roller part 100, and rotates by engaging with the support roller part 100.

The anti-adhesion fluid supplying unit 300 is installed on the upper portion of the half-cutting roller part 200, and is provided to apply an anti-adhesion fluid 30 on the surface of the half cutter 210 (see FIG. 3) coming into contact with the printed part 10a of the sticker sheet 10.

The sticker half-cutting apparatus may include a release paper separation rollers 400 so as to make the sticker sheet 10 passing through the support roller part 100 and the half-cutting roller part 200 be a complete product while being transferred along the conveyance path (A).

That is, the release paper separation rollers 400 are spaced from each other along the upper portion and the lower portion, and separate the release paper 14 from the printed part 10a of the sticker sheet 10, thereby leaving only the shape part 20 on the surface of the release paper 14. Accordingly, a sticker complete product from which a user can easily detach the shape part 20 can be manufactured.

FIG. 3 is an exploded perspective view showing a structure of a sticker half-cutting apparatus according to an exemplary embodiment of the present invention, and FIG. 4 is a perspective view showing a half-cutting roller part of the sticker half-cutting apparatus according to an exemplary embodiment of the present invention.

As shown in FIG. 3, the sticker half cutting apparatus includes a support roller part 100, a half-cutting roller part 200, and the anti-adhesion fluid supplying unit 300.

The support roller part 100 rotates while supporting the lower portion of a sticker sheet 10 transferred along a conveyance path (A).

The half-cutting roller part 200 is installed on the upper portion of the support roller part 100 and rotates by engaging with the support roller part 200, and includes a half cutter 210 for cutting a printed part 10a of the sticker sheet 10 passing through the support roller part 100.

To achieve this, the half-cutting roller part 200 includes a cylinder member 220 and a half-cutting member 230.

The cylinder member 220 is formed in the same shape and the same size as those of the support roller part 100, so as to rotate by engaging with the support roller part 100.

The cylinder member 220 may be formed of a magnetic material having magnetism, and may rotate in close contact with the support roller part 100 by magnetism, and accordingly, may press the printed part 10a of the sticker sheet 10, such that a shape part 20 is easily cut.

The half-cutting member 230 is connected with the outer circumference of the cylinder member 220, and is formed to have the plurality of half cutters 210 protruding therefrom.

As shown in FIG. 4, the half-cutting member 230 is formed in the shape of ‘C’ so as to be easily attached to and detached from the outer circumference of the cylinder member 220, and fits over the outer circumference of the cylinder member 220.

Accordingly, the half-cutting member 230 may be replaced with a half-cutting member 230 having half cutters 210 of different shapes.

The half-cutting member 230 may be formed to have elasticity. This is to make it easy to attach and detach the half-cutting member 230 to and from the outer circumference of the cylinder member 220 when the half-cutting member 230 is replaced.

The anti-adhesion fluid supplying unit 300 applies an anti-adhesion fluid 30 on the surface of the half-cutter 210 coming into contact with the printed part 10a of the sticker sheet 10.

To achieve this, the anti-adhesion fluid supplying unit 300 includes an anti-adhesion fluid application roller part 310.

The anti-adhesion fluid application roller part 310 adsorbs the anti-adhesion fluid 30 and rotates by engaging with the half-cutting roller part 200, and is formed to apply the adsorbed anti-adhesion fluid 30 on the surface of the half cutter 210 of the half-cutting roller part 200 by rotation.

In the present embodiment, the anti-adhesion fluid application roller part 310 is disposed on the upper portion of the half-cutting roller part 200. However, this should not be considered as limiting. According to the present invention, there may be various variations such as the anti-adhesion fluid application roller part 310 being disposed on the side portion of the half-cutting roller part 200.

The anti-adhesion fluid application roller part 310 includes a roller member 312 and an anti-adhesion fluid application member 314.

The roller member 312 is formed to have a diameter smaller than the diameter of the half-cutting roller part 200, and rotates by engaging with the half-cutting roller part 200, and includes the anti-adhesion fluid application member 314 formed on the center of the outer circumference of the roller member 312.

The anti-adhesion fluid application member 314 is formed to adsorb the anti-adhesion fluid 30, and is connected with the outer circumference of the roller member 310 and has a size corresponding to the size of the half cutter 210. The anti-adhesion fluid 30 may be manually sprayed directly by an operator or may be automatically sprayed by a separate spray device.

The anti-adhesion fluid application member 314 may be formed of a porous moisture absorption material such as sponge, and may be formed to include a nonwoven fabric formed of a fabric of a synthetic fiber or a natural fiber having a high moisture absorption property.

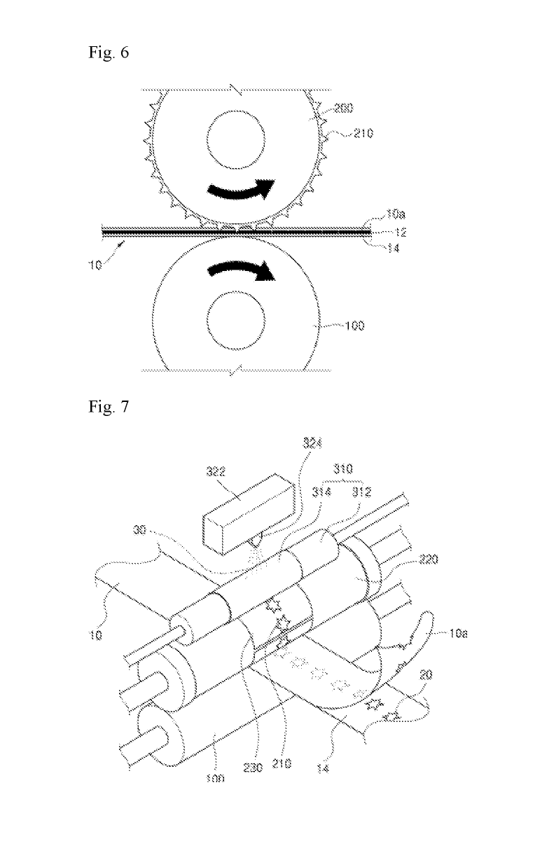

FIG. 5 is a perspective view showing the operation of the sticker half-cutting apparatus according to an exemplary embodiment of the present invention, and FIG. 6 is a cross section view showing the sticker half-cutting apparatus which cuts the sticker sheet according to an exemplary embodiment of the present invention.

As shown in FIG. 5, the sticker sheet 10 passes between the support roller part 100 and the half-cutting roller part 200 and is transferred along the conveyance path (A), such that the shape part 20 is cut from the printed part 10a.

That is, the half cutter 210 having a predetermined pattern is provided on the outer circumference of the half-cutting roller part 200, and the half cutter 210 presses and cuts the sticker sheet 10 while rotating with the support roller part 100 on the outer circumference of the half-cutting roller part 200, such that the shape part 20 is cut from the printed part 10a of the sticker sheet 10 passing between the support roller part 100 and the half-cutting roller part 200.

In addition, the anti-adhesion fluid supplying unit 300 is provided on the upper portion or side portion of the half-cutting roller part 200, and the anti-adhesion fluid supplying unit 300 provided in this way applies the anti-adhesion fluid 30 on the half cutters 210 of the half-cutting roller part 200.

The anti-adhesion fluid supplying unit 300 includes the anti-adhesion fluid application roller part 310, and the anti-adhesion fluid application roller part 310 rotates by engaging with the rotating half-cutting roller part 200, and comes into contact with the half cutter 210 with the anti-adhesion fluid 30 being contained therein, thereby applying the anti-adhesion fluid 30 on the surface of the half cutter 210.

In this case, the anti-adhesion fluid 30 may be formed of a slippery material such as silicon or oil, such that the shape part 20 of the sticker sheet 10 is prevented from sticking to the surface of the half cutter 210 due to the adhesive 12 coated on the half cutter 210 when the shape part 20 is cut from the sticker sheet 10 by the haft cutter 210.

Referring to FIG. 6, in the process in which the half cutters 210 comes into contact with the sticker sheet 10 and cuts the shape part 20, the adhesive 12 applied on the sticker sheet 10 may stick to the surface of the half cutter 210. The adhesive 12 sticking to the surface of the half cutter 210 may cause the shape part 20 cut by the half cutter to stick to the half cutter 210, resulting in a defect in a product.

The sticker half-cutting apparatus according to the present embodiment applies the anti-adhesion fluid 30, which acts so as to prevent the adhesive 12 from sticking to the half cutter 210, is applied on the surface of the half cutter 210, such that the shape parts 20 can be prevented from sticking to the half cutter 210. The above-described operations will be described in detail hereinbelow.

When the support roller 100 and the half-cutting roller part 200 rotate by engaging with each other so as to cut the shape part 20 from the sticker sheet 10 transferred along the conveyance path (A), the anti-adhesion fluid application roller part 310 rotates by engaging with the half-cutting roller part 200.

In this case, when the anti-adhesion fluid 30 is applied to the anti-adhesion fluid application roller part 310, the anti-adhesion fluid 30 is adsorbed onto the application roller part 310. The anti-adhesion fluid 30 adsorbed onto the application roller part 310 in this way is transferred to the half-cutting roller part 200 by being coated on the surface of the half-cutting roller part 200 which rotates in contact with the application roller part 310.

As described above, the anti-adhesion fluid 30 is coated on the surface of the half-cutting roller part 200, such that the anti-adhesion fluid 30 is applied on the surface of the half cutter 210, and the anti-adhesion fluid 30 applied on the surface of the half-cutter 210 as described above forms a release layer on the surface of the half-cutter 210 and thus prevents the adhesive 12 applied to the sticker sheet 10 from sticking to the half cutter 210.

The sticker half-cutting apparatus according to the present embodiment prevents the cut shape part 20 from sticking to the half cutter 210 by applying the anti-adhesion fluid 30 on the half-cutting roller part 200, such that a defect can be prevented when a sticker complete product is produced, and a process of removing the shape part 20 which may frequently occur due to a defect can be reduced, such that a production speed for producing the sticker complete product can be enhanced.

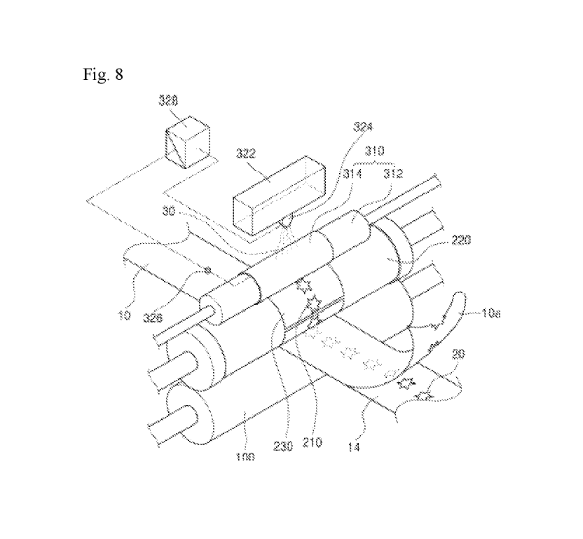

Hereinafter, FIG. 7 is a perspective view showing a sticker half-cutting apparatus according to another exemplary embodiment of the present invention, and FIG. 8 is a perspective view showing the operation of the sticker half-cutting apparatus according to another exemplary embodiment of the present invention.

As shown in FIGS. 7 and 8, the sicker half-cutting apparatus includes an anti-adhesion fluid supplying unit 300 for applying an anti-adhesion fluid 30 on the surface of a half cutter 210 coming into contact with a printed part 10a of a sticker sheet 10.

The anti-adhesion fluid supplying unit 300 may include an anti-adhesion fluid application roller part 310 and an anti-adhesion fluid supply part 320.

The anti-adhesion fluid application roller part 310 adsorbs the anti-adhesion fluid 30, rotates by engaging with a half-cutting roller part 200, and adsorbs the anti-adhesion fluid 30 and applies the anti-adhesion fluid 30 on the surface of the half cutter 210. The anti-adhesion fluid application roller part 310 may be disposed on the upper portion of the half-cutting roller part 200 or may be disposed on the side portion of the half-cutting roller part 200.

The anti-adhesion fluid supply part 320 supplies the anti-adhesion fluid 30 to the anti-adhesion fluid application roller part 310, and includes an anti-adhesion fluid supply tank 322 and a spray nozzle 324.

The anti-adhesion fluid supply tank 322 is formed to have a predetermined inner space for storing the anti-adhesion fluid 30. In addition, the spray nozzle 324 is installed adjacent to the anti-adhesion fluid application roller part 310.

The spray nozzle 324 sprays the anti-adhesion fluid 30 stored in the anti-adhesion fluid supply tank 322 onto the anti-adhesion fluid application roller part 310, and is operated to spray the anti-adhesion fluid 30 toward an anti-adhesion fluid application member 314 enclosing the outer circumference of the anti-adhesion fluid application roller part 310.

For example, the spray nozzle 324 may be installed in plural numbers along the longitudinal direction of the anti-adhesion fluid supply tank 322 to correspond to the length of the anti-adhesion fluid application member 314.

In another example, the spray nozzle 324 may be formed to be movable along the longitudinal direction of the anti-adhesion fluid application member 314. In this case, the spray nozzle 324 reciprocates in the longitudinal direction of the anti-adhesion fluid application member 314, and is operated to uniformly spray the anti-adhesion fluid 30 toward the application member 314.

The anti-adhesion fluid supply part 320 may further include a controller 328 to control the operation of the spray nozzle 324.

For example, the controller 328 may control the operation of the spray nozzle 324 to spray the anti-adhesion fluid 30 toward the anti-adhesion fluid application member 314 at a predetermined time interval.

That is, the controller 328 may control the operation of the spray nozzle 324 at a predetermined spray time interval to adjust the spray interval of the spray nozzle 324, and accordingly, control to supply an appropriate amount of the anti-adhesion fluid 30 to the anti-adhesion fluid application member 314 at the right time, such that the amount of the anti-adhesion fluid 30 supplied to the anti-adhesion fluid application member 314 can be always maintained at an appropriate level.

As described above, the sticker half-cutting apparatus which adjusts the supply of the anti-adhesion fluid 30 automatically supplies the anti-adhesion fluid 30, such that operation convenience can be enhanced, and also, the amount of the anti-adhesion fluid 30 supplied to the anti-adhesion fluid application member 314 is always maintained at an appropriate level, such that operation efficiency can be enhanced.

In another example, the anti-adhesion fluid supply part 320 may further include a measurement sensor 326 and the controller 328.

The measurement sensor 326 is connected with the anti-adhesion fluid application member 314 to measure a degree of adsorption of the anti-adhesion fluid 30 supplied from the anti-adhesion fluid supply tank 322 on the anti-adhesion fluid application member 314.

In addition, the controller 328 controls the operation of the spray nozzle 324 according to the degree of adsorption of the anti-adhesion fluid 30 to adjust the amount of the anti-adhesion fluid 30 to be supplied.

In order to measure the degree of adsorption of the anti-adhesion fluid 30 supplied to the anti-adhesion fluid application member 314, the controller 328 compares the degree of adsorption of the anti-adhesion fluid 30 on the anti-adhesion fluid application member 314 measured first by the measurement sensor 326, and a predetermined average degree of adsorption of the anti-adhesion fluid 30.

In this case, when it is determined that the degree of adsorption of the anti-adhesion fluid 30 on the anti-adhesion fluid application member 314 is lower than the predetermined average degree of adsorption of the anti-adhesion fluid 30, the controller 328 may control the spray nozzle 324 to increase the amount of the anti-adhesion fluid 30 to be supplied to the anti-adhesion fluid application member 314.

In addition, the controller 328 may control the amount of the anti-adhesion fluid 30 to be supplied by controlling the spray time or spray interval of the spray nozzle 324. When it is determined that the degree of adsorption of the anti-adhesion fluid 30 on the anti-adhesion fluid application member 314 is higher than the predetermined average degree of adsorption of the anti-adhesion fluid 30, the controller 328 may control the spray time or spray time interval to be shortened and may reduce the amount of the anti-adhesion fluid 30 to be supplied.

That is, the controller 328 adjusts the spray time or spray interval of the spray nozzle 324 according to the degree of adsorption of the anti-adhesion fluid 30 measured by the measurement sensor 326, such that the degree of adsorption of the anti-adhesion fluid 30 on the anti-adhesion fluid application member 314 can be maintained at an appropriate level.

According to the present invention, a separate roller holding a slippery liquid therein is installed on the upper portion of a magnetic cylinder connected with a processed half cutter, and applies the slippery liquid to the half cutter when the magnetic cylinder rotates, such that the adhesive of the sticker can be prevented from sticking to the half cutter.

In addition, the present invention can prevent a part of the sticker sheet cut through the half cutter from sticking to the half cutter, such that a defect rate can be reduced when a sticker complete product is produced, and accordingly, there is an effect of increasing a production speed according to the production of the sticker complete product.

While the invention has been shown and described with reference to certain preferred embodiments thereof, it will be understood by those skilled in the art that these embodiments are merely examples and various changes may be made therein without departing from the spirit and scope of the invention as defined by the appended claims. In addition, it will be understood that all or a part of the above-described embodiments may be selectively combined and configured. Therefore, the scope of the invention is defined not by the detailed description of the invention but by the appended claims.

### EXPLANATIONS OF SIGNS

10: sticker sheet
10a: printed part
12: adhesive
14: release paper
20: shape part
30: anti-adhesion fluid
100: support roller part
200: half-cutting roller part
210: half cutter
220: cylinder member
230: half-cutting member
300: anti-adhesion fluid supplying unit
310: anti-adhesion fluid application roller part
312: roller member
314: anti-adhesion fluid application member
320: anti-adhesion fluid supply part
322: anti-adhesion fluid supply tank
324: spray nozzle
326: measurement sensor
328: controller
400: release paper separation roller

What is claimed is:

1. A sticker half-cutting apparatus comprising:
a support roller part which rotates while supporting the lower portion of a transferred sticker sheet;
a half-cutting roller part which is installed on the upper portion of the support roller part to rotate by engaging with the support roller part, and includes a half cutter for cutting a printed part of the sticker sheet passing through the support roller part; and
an anti-adhesion fluid supplying unit which applies an anti-adhesion fluid on the surface of the half cutter coming into contact with the printed part of the sticker sheet.

2. The sticker half-cutting apparatus of claim 1, wherein the anti-adhesion fluid supplying unit comprises:
an anti-adhesion fluid application roller part which adsorbs the anti-adhesion fluid and rotates by engaging with the half-cutting roller part, and applies the anti-adhesion fluid on the surface of the half cutter; and
an anti-adhesion fluid supply part which supplies the anti-adhesion fluid to the anti-adhesion fluid application roller part.

3. The sticker half-cutting apparatus of claim 2, wherein the anti-adhesion fluid application roller part comprises:
a roller member which rotates by engaging with the half-cutting roller part; and
an anti-adhesion fluid application member which is connected with the outer circumference of the roller member to adsorb the anti-adhesion fluid supplied from the anti-adhesion fluid supply part, and which comes contact with the half cutter to apply the adsorbed anti-adhesion fluid on the surface of the half cutter.

4. The sticker half-cutting apparatus of claim 3, wherein the anti-adhesion fluid application member is formed of a porous moisture absorption material.

5. The sticker half-cutting apparatus of claim 1, wherein the half-cutting roller part comprises:
a cylinder member which rotates by engaging with the support roller part; and
a half-cutting member which is connected with the outer circumference of the cylinder member and has a plurality of half cutters protruding therefrom.

6. The sticker half-cutting apparatus of claim 5, wherein the half-cutting member is attachably and detachably installed on the outer circumference of the cylinder member.

7. The sticker half-cutting apparatus of claim 1, wherein the anti-adhesion fluid is formed of a material comprising silicon or oil.

8. The sticker half-cutting apparatus of claim 2, wherein the anti-adhesion fluid supply part comprises:
an anti-adhesion fluid supply tank which stores the anti-adhesion fluid;
a spray nozzle which is installed on the anti-adhesion fluid supply tank to supply the anti-adhesion fluid to the anti-adhesion fluid application roller part; and
a controller which controls the operation of the spray nozzle.

9. The sticker half-cutting apparatus of claim 8, wherein the controller controls spraying of the spray nozzle to spray the anti-adhesion fluid at a predetermined time interval.

10. The sticker half-cutting apparatus of claim 8, wherein the anti-adhesion fluid supply part further comprises a measurement sensor which measures a degree of adsorption of the anti-adhesion fluid supplied to the anti-adhesion fluid application roller part.
